(19) United States
(12) Patent Application Publication
(10) Pub. No.: US 2026/0046467 A1
(43) Pub. Date: Feb. 12, 2026

(54) PORTABLE TV AND METHOD FOR CONTROLLING PORTABLE TV

(71) Applicant: LG ELECTRONICS INC., Seoul (KR)

(72) Inventors: Donghee LEE, Seoul (KR); Taejin PARK, Seoul (KR); Sunho HWANG, Seoul (KR)

(73) Assignee: LG ELECTRONICS INC., Seoul (KR)

(21) Appl. No.: 19/103,099

(22) PCT Filed: Aug. 12, 2022
(86) PCT No.: PCT/KR2022/012086

§ 371 Date: Feb. 11, 2025

(51) Int. Cl. H04N 21/414; H04N 21/41; H04N 21/422; H04N 21/45

(52) U.S. Cl. CPC H04N 21/414; H04N 21/4104; H04N 21/42203; H04N 21/4524

(57) ABSTRACT

The present invention relates to a portable TV comprising: a display module for outputting content; a housing for accommodating the display module; four legs detachable from a lower case of the housing; and a control unit. The control unit detects when an upper case of the housing is opened, determines the current location of the TV, determines whether the current location is the same as the location immediately before a shutdown, and if the current location is the same as the location immediately before the shutdown, operates in the mode immediately before the shutdown. The mode includes a first mode and a second mode, wherein the first mode is a mode in which the display module maintains a state of being coupled to the housing, and the second mode is a state in which the display module stands in the housing.

### TECHNICAL FIELD

The present disclosure relates to a portable TV and a method for controlling a portable TV.

### BACKGROUND ART

Recently, a new form factor has been discussed in multimedia devices such as mobile phones and TVs. A form factor refers to the structured form of a product.

The background of the importance of form factor innovation in the display industry is that, due to the increased mobility of consumers, rapid advancement of convergence and smartness between devices, and the like, users have a growing need for form factors that can be used freely and conveniently regardless of conditions of usage environments, breaking away from typical form factors tailored to specific usage environments in the past.

For example, vertical TVs are expanding, breaking the stereotype of watching TV horizontally. Vertical TVs are products that allow screen orientation changes, reflecting the characteristics of the MZ generation who are accustomed to enjoying content on mobile devices. Vertical TVs are convenient because users can easily view images from SNSs or shopping sites, and read comments while watching videos. In particular, vertical TVs have more advantages when connected with a smartphone through a near-field communication (NFC)-based mirroring function. When watching regular TV or movies, users can switch to landscape mode.

As another example, both rollable TVs and foldable smartphones are similar in that they both use a “flexible display”. A flexible display literally refers to a flexible electronic device. In order to be flexible, it must first be thin. A substrate that receives information and converts the same into light needs to be thin and flexible to maintain performance without damage for a long time.

Being flexible means that it should not be greatly affected even when subjected to impact. While a flexible display is bent or folded, joints are continuously subjected to pressure. Flexible displays need to be durable enough to prevent internal damage from such pressure and also have the property of being able to deform freely when pressure is applied.

Flexible displays are implemented based on OLEDs, for example. OLED displays use organic light-emitting materials. Organic materials are relatively more flexible than inorganic materials such as metals. Furthermore, OLEDs can utilize a thin substrate, making OLEDs more competitive than other displays. In the case of LCD substrates used in the past, there is a limit to reducing the thickness because separate liquid crystals and glass are required.

Finally, as a new form factor for TVs, demand for TVs that can be easily moved indoors and outdoors is increasing. In particular, due to the recent coronavirus pandemic, users are spending more time at home, and demand for second TVs is increasing. In addition, due to the increase in people going outdoors for camping and other activities, there is a demand for a new form factor TV that can be easily carried and moved.

### TECHNICAL TASK

An object of the present disclosure is to solve the above-mentioned problems and other problems.

An object of the present disclosure is to provide a TV and a method for controlling a TV.

### TECHNICAL SOLUTIONS

In an aspect of the present disclosure, a portable TV includes a display module for outputting content, a housing accommodating the display module, four legs attachable/detachable to/from a lower case of the housing, and a controller, wherein the controller is configured to detect opening of an upper case of the housing, determine a current location of the TV, determine whether the current location is the same as a location immediately before shutdown, and operate in a mode immediately before shutdown if the current location is the same as the location immediately before shutdown, wherein the mode includes a first mode and a second mode, wherein the first mode is a mode in which the display module maintains a state of being coupled with the housing, and the second mode is a mode in which the display module is in a standing state in the housing.

The controller may automatically connect a first external device last connected to the TV when operating in the mode immediately before shutdown.

The controller may output an audio signal of the first external device through an audio output unit attached to the upper case of the housing when the TV operates in the first mode.

The controller may output a content selection screen on the display module when the TV operates in the second mode.

When the current location is different from the location immediately before shutdown, the TV may operate in a third mode, and the controller may connect a second external device connectable on the basis of user selection.

The controller may determine a time immediately before shutdown of the TV, and when a current time is different from the time immediately before shutdown, the TV may operate in the third mode.

The portable TV may further include a microphone, wherein the controller may determine the current location of the TV on the basis of first noise information received through the microphone, and the noise information may include a noise pattern.

The controller may collect second noise information received through the microphone when the upper case of the housing is opened, and compare a noise pattern included in the second noise information with existing noise patterns.

The portable TV may further include an illuminance sensor, wherein the controller may determine the current location of the TV on the basis of an amount of light detected through the illuminance sensor.

The portable TV may further include a network interface unit, wherein the controller may receive location information of the TV through the network interface unit, and determine the current location of the TV on the basis of the location information.

The network interface unit may be connected to a server, and the controller may receive image information regarding the current location of the TV from the server, and output the image information through the display module.

The controller may receive the image information on the basis of the current time.

In an aspect of the present disclosure, a method of controlling a portable TV, which includes a display module for outputting content, a housing accommodating the display module, and four legs attachable/detachable to/from a lower case of the housing, includes detecting opening of an upper case of the housing, determining a current location of the TV, determining whether the current location is the same as a location immediately before shutdown, and operating in a mode immediately before shutdown if the current location is the same as the location immediately before shutdown, wherein the mode includes a first mode and a second mode, wherein the first mode is a mode in which the display module maintains a state of being coupled with the housing, and the second mode is a mode in which the display module is in a standing state in the housing.

The method may further include automatically connecting a first external device last connected to the TV when the mode immediately before shutdown is executed.

The method may further include outputting a content selection screen on the display module when the TV operates in the second mode.

The method may further include operating the TV in a third mode when the current location is different from the location immediately before shutdown, wherein the third mode is a mode for connecting a second external device connectable on the basis of user selection.

### ADVANTAGEOUS EFFECTS

The effects of the portable TV and the method of controlling a portable TV according to the present disclosure will be described as follows.

According to the portable TV and the method of controlling a portable TV according to the present disclosure, a TV mode can be executed differently based on the current location of the TV. Accordingly, a user can move and use the portable TV, and the portable TV can automatically execute a mode in which the most appropriate operation is performed.

Additional scope of the applicability of the present disclosure will become apparent from the detailed description below.

However, since various changes and modifications can be clearly understood by those skilled in the art within the spirit and scope of the present disclosure, it should be understood that the detailed description and specific embodiments such as preferred embodiments of the present disclosure are given only as examples.

### DESCRIPTION OF DRAWINGS

FIG. 1 is a block diagram illustrating constituent elements of a TV according to an embodiment of the present disclosure.

FIG. 2 is a diagram showing the TV according to an embodiment of the present disclosure.

FIG. 3 is a diagram showing an example of using the TV according to an embodiment of the present disclosure.

FIG. 4 is another diagram showing an example of using the TV according to an embodiment of the present disclosure.

FIG. 5 is a diagram showing the front and side of the TV according to an embodiment of the present disclosure.

FIG. 6 is a diagram illustrating modes of the TV according to an embodiment of the present disclosure.

FIG. 7a and FIG. 7b are diagrams illustrating an example of connecting a device based on a mode of the TV according to an embodiment of the present disclosure.

FIG. 8 is a diagram illustrating an example of detecting movement of the TV according to an embodiment of the present disclosure.

FIG. 9 is a diagram illustrating an example of outputting an image based on situation information of the TV according to an embodiment of the present disclosure.

FIG. 10 is a flowchart illustrating a method of controlling a TV according to one embodiment of the present disclosure.

### BEST MODE FOR DISCLOSURE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with”another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

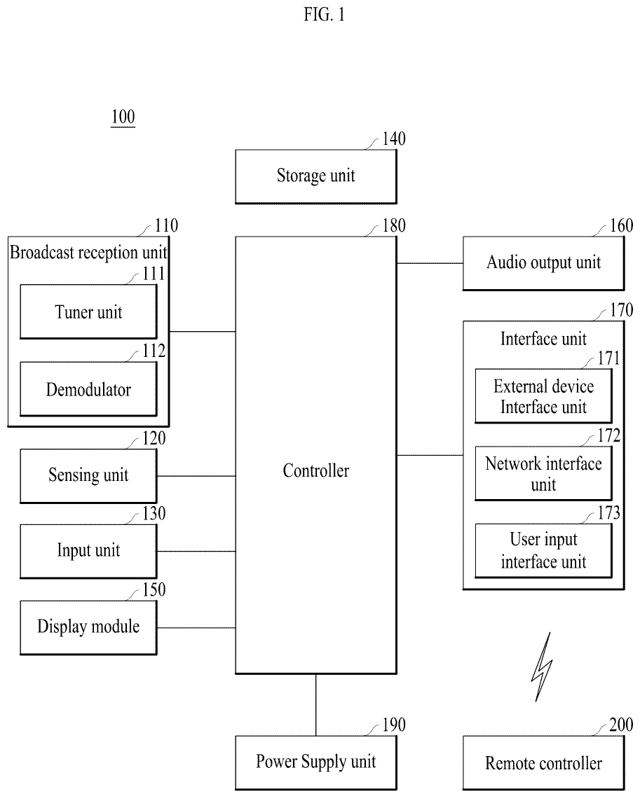

FIG. 1 is a block diagram illustrating constituent elements of a TV 100 according to an embodiment of the present disclosure.

Referring to FIG. 1, the TV 100 may include a broadcast reception unit 110, an external device interface unit 171, a network interface unit 172, a storage unit 140, a user input interface unit 173, an input unit 130, a controller 180, a display 150, an audio output unit 160, and/or a power-supply unit 190.

The broadcast reception unit 110 may include a tuner unit 111 and a demodulator 112.

Although not shown in the drawings, the TV 100 may include only the external device interface unit 171 and the network interface unit 172 from among the broadcast reception unit 110, the external device interface unit 171, and the network interface unit 172. That is, the TV 100 may not include the broadcast reception unit 110.

The tuner unit 111 may select a broadcast signal corresponding to either a user-selected channel or all prestored channels from among broadcast signals received through an antenna (not shown) or a cable (not shown). The tuner unit 111 may convert the selected broadcast signal into an intermediate frequency (IF) signal or a baseband image or a voice signal.

For example, when the selected broadcast signal is a digital broadcast signal, the tuner unit 111 may convert the selected broadcast signal into a digital IF (DIF) signal. When the selected broadcast signal is an analog broadcast signal, the tuner unit 111 may convert the selected broadcast signal into an analog baseband image or a voice signal (CVBS/SIF). That is, the tuner unit 111 may process the digital broadcast signal or the analog broadcast signal. The analog baseband image or the voice signal (CVBS/SIF) output from the tuner unit 111 may be directly input to the controller 180.

The tuner unit 111 may sequentially select broadcasting signals of all broadcasting channels stored through a channel memory function from among the received broadcast signals, and may convert the selected broadcast signal into an intermediate frequency (IF) signal or a baseband image or a voice signal.

The tuner unit 111 may include a plurality of tuners to receive broadcast signals of the plurality of channels. Alternatively, a single tuner for simultaneously receiving broadcast signals of the plurality of channels is also possible.

The demodulator 112 may receive the digital IF signal (DIF) converted by the tuner unit 111, and may thus perform demodulation of the received signal. The demodulator 112 may perform demodulation and channel decoding, and may output a stream signal (TS). The stream signal may be a signal formed by multiplexing an image signal, a voice signal, or a data signal.

The stream signal (TS) output from the demodulator 112 may be input to the controller 180. The controller 180 may perform demultiplexing, image/audio signal processing, etc., may output an image through the display 150, and may output a voice through the audio output unit 160.

The sensing unit 120 may sense a change in the TV 100 or may sense an external change. For example, the sensing unit 120 may include a proximity sensor, an illumination sensor, a touch sensor, an infrared (IR) sensor, an ultrasonic sensor, an optical sensor (e.g., a camera), a voice sensor (e.g., a microphone), a battery gauge, environmental sensors (e.g., hygrometer, a thermometer, etc.).

The controller 180 may check a state of the TV 100 based on information collected by the sensing unit 120, may notify the user of a problem, or may control the TV 100 to be kept in the best state.

In addition, it is possible to provide an optimal viewing environment by differently controlling the content, image quality, size, etc. of the image provided to the display module 180 depending on the viewer, ambient illuminance, etc. sensed by the sensing unit. As the smart TV has evolved, the number of functions mounted in the display device increases, and the number of the sensing units 20 also increases together with the increasing functions.

The input unit 130 may be provided at one side of a main body of the TV 100. For example, the input unit 130 may include a touch pad, a physical button, and the like. The input unit 130 may receive various user commands related to the operation of the TV 100, and may transmit a control signal corresponding to the input command to the controller 180.

Recently, as a bezel of the TV 100 decreases in size, the number of display devices 100 each including a minimum number of input unit 130 formed in a physical button exposed to the outside is rapidly increasing. Instead, a minimum number of physical buttons may be provided on the back or side surface of the TV 100. The display device may receive a user input through the remote controller 200 through a touchpad or a user input interface unit 173 to be described later.

The storage unit 140 may store a program for processing and controlling each signal used in the controller 180, and may store a signal-processed image, a voice, or a data signal. For example, the storage unit 140 may store application programs designed for the purpose of performing various tasks that can be processed by the controller 180, and may selectively provide some of the stored application programs upon request of the controller 180.

The program stored in the storage unit 140 is not specifically limited to being executed by the controller 180. The storage unit 140 may perform a function for temporarily storing an image, a voice, or a data signal received from an external device through the external device interface unit 171. The storage unit 140 may store information about a predetermined broadcast channel through a channel memory function such as a channel map.

Although the storage unit 140 of FIG. 1 is provided separately from the controller 180, the scope of the present disclosure is not limited thereto, and the storage unit 140 may also be included in the controller 180 as needed.

The storage unit 140 may include at least one of a volatile memory (e.g., DRAM, SRAM, SDRAM, etc.) and a non-volatile memory (e.g., flash memory, hard disk drive (HDD), solid state drive (SSD), etc.).

The display 150 may generate a drive signal by converting an image signal, a data signal, an OSD signal, a control signal processed by the controller 180, or by converting an image signal, a data signal, a control signal, etc. received from the interface unit 171. The display 150 may include a display panel 181 having a plurality of pixels.

A plurality of pixels included in the display panel may include RGB sub-pixels. Alternatively, a plurality of pixels included in the display panel may include sub-pixels of RGBW. The display 150 may convert the image signal, the data signal, the OSD signal, the control signal, etc. processed by the controller 180 to generate a drive signal for the plurality of pixels.

The display 150 may be implemented as a plasma display panel (PDP), a liquid crystal display (LCD), an organic light emitting diode (OLED), a flexible display, etc. In addition, the display 150 may also be implemented as a three-dimensional (3D) display. The three-dimensional (3D) display 150 may be classified into a glassless-type 3D display and a glasses-type 3D display.

The display device may include a display module that occupies most parts of the front surface, and a case that covers the back and side surfaces of the display module and packages the display module.

Recently, the TV 100 has evolved from a flat-screen display to a curved-screen display. In order to implement the curved screen, the TV 100 may use a display module 150 that can be bent or curved, such as a light emitting diode (LED) or an organic light emitting diode (OLED), etc.

Conventionally, the LCD has difficulty in self-emitting light, so that the conventional LCD has been designed to receive light through a backlight unit. The backlight unit is a device for uniformly supplying light received from a light source to a liquid crystal located on the front surface of the display device. As the backlight becomes thinner, a thin LCD can be implemented. However, it is actually difficult for the backlight unit to be implemented as a curved structure formed of a flexible material. Although the backlight unit is implemented as a curved shape, it is difficult for light to be uniformly applied to the liquid crystal, thereby changing brightness of the screen.

On the other hand, the LED or the OLED is designed in a manner that each of constituent elements constructing the pixels can self-emit light without using the backlight unit, so that the LED or the OLED can be implemented as a curved shape without any problems. In addition, since each element can perform self-emission of light, brightness of each element is not affected by a change in the positional relationship between the element and adjacent elements, so that a curved display module 150 can be implemented as an LED or OLED.

OLED (Organic Light Emitting Diode) panels appeared in earnest in mid-2010 and are rapidly replacing LCDs in the small-and medium-sized display market. The OLED is a display made using the self-emission characteristics in which OLED emits light when a current flows in a fluorescent organic compound. Since the response speed of the OLED is faster than that of the LCD, there is little afterimage when moving images are implemented.

OLEDs may be used as a light-emitting display product. In this case, the light-emitting display device may use three fluorescent organic compounds (such as red, green, and blue) each having a self-emitting function, and may use the self-emitting phenomenon in which positive(+)-charged particles and electrons injected from a cathode and anode are combined with each other within the organic material, so that a backlight unit causing degradation of color sense need not be used.

The LED panel is implemented by technology for using only one LED element as one pixel, and has a smaller LED element compared to the prior art, so that a curved display module 150 can be implemented. Whereas the conventional device referred to as an LED TV can use the LED as a light source of the backlight unit for supplying light to the LCD, it is impossible for the LED of the conventional device to constitute a screen.

The display module may include a display panel, a coupling magnet located on the rear surface of the display panel, a first power-supply unit, and a first signal module. The display panel may include a plurality of pixels (R, G, B). The plurality of pixels (R, G, B) may be formed in each region where a plurality of data lines and a plurality of gate lines cross each other. The plurality of pixels (R, G, B) may be arranged in a matrix.

For example, the plurality of pixels (R, G, B) may include a red(R) sub-pixel, a green(G) sub-pixel, and a blue(B) sub-pixel. The plurality of pixels (R, G, B) may further include white (W) sub-pixel(s).

In the display module 150, one side where an image is displayed may be referred to as a front side or a front surface. When the display module 150 displays an image, one side where no image is observed may be referred to as a rear side or a rear surface.

Meanwhile, the display 150 may be implemented as a touchscreen, so that the display 150 can also be used as an input device in addition to an output device.

The audio output unit 160 may receive a voice-processed signal from the controller 180, and may output the received signal as a voice signal.

The interface unit 170 may serve as a path of connection to various kinds of external devices connected to the TV 100. The interface unit may include not only a wired method for transmitting/receiving data through a cable, but also a wireless method using the antenna.

The interface unit 170 may include at least one of a wired/wireless headset port, an external charger port, a wired/wireless data port, a memory card port, a port connected to a device having an identification module, an audio input/output (I/O) port, a video I/O port, and an earphone port.

As an example of a wireless method, the above-described broadcast reception unit 110 may be used. The broadcast reception unit 110 may be configured to use a broadcast signal, a mobile communication short-range communication signal, a wireless Internet signal, and the like.

The external device interface unit 171 may transmit or receive data to and from a connected external device. To this end, the external device interface unit 171 may include an A/V input/output (I/O) unit (not shown).

The external device interface unit 171 may be wired or wirelessly connected to an external device such as a digital versatile disc (DVD) player, a Blu-ray player, a game console, a camera, a camcorder, a computer (laptop), a set-top box, or the like, and may perform an input/output (I/O) operation with the external device.

In addition, the external device interface unit 171 may establish a communication network with various remote controllers 200, may receive a control signal related to operation of the TV 100 from the remote controller 200, or may transmit data related to operation of the TV 100 to the remote controller 200.

The external device interface unit 171 may include a wireless communication unit (not shown) for short-range wireless communication with other electronic devices. Through the wireless communication unit (not shown), the external device interface unit 171 may exchange data with an adjacent mobile terminal. In particular, the external device interface unit 171 may receive device information, application information, an application image, and the like from the mobile terminal in a mirroring mode.

The network interface unit 172 may provide an interface for connecting the TV 100 to a wired/wireless network including the Internet network. For example, the network interface unit 172 may receive content or data provided by the Internet, a content provider, or a network administrator through a network. The network interface unit 172 may include a communication module (not shown) for connection with the wired/wireless network.

The external device interface unit 171 and/or the network interface unit 172 may include a communication module for short-range communication such as Wi-Fi, Bluetooth, Bluetooth low energy (BLE), ZigBee, Near Field Communication (NFC), and a communication module for cellular communication such as Long-Term Evolution (LTE), LTE-A (LTE Advanced), Code Division Multiple Access (CDMA), WCDMA (wideband CDMA), UMTS (universal mobile telecommunications system), WiBro (Wireless Broadband), etc.

The user input interface unit 173 may transmit user input signals to the controller 180, or may transmit signals received from the controller 180 to the user. For example, the user input interface unit 173 may transmit or receive user input signals (such as a power-on/off signal, a channel selection signal, and a screen setting signal) to and from the remote controller 200, may transmit user input signals received through a local key (not shown) such as a power key, a channel key, a volume key, and a setting key to the controller 180, may transmit a user input signal received by a sensor unit (not shown) for sensing a user gesture to the controller 180, or may transmit a signal received from the controller 180 to the sensor unit.

The controller 180 may include at least one processor, and may control the overall operation of the TV 100 using the processor included therein. Here, the processor may be a general processor such as a CPU. Of course, the processor may be a dedicated device such as an ASIC, or other hardware-based processor.

The controller 180 may demultiplex the stream received through the tuner unit 111, the demodulator 112, the external device interface unit 171, or the network interface 172, and may process the demultiplexed signals to generate and output a signal for image or voice output.

The image signal processed by the controller 180 may be input to the display 150 and displayed as an image corresponding to the corresponding image signal. In addition, the image signal processed by the controller 180 may be input to the external output device through the external device interface unit 171.

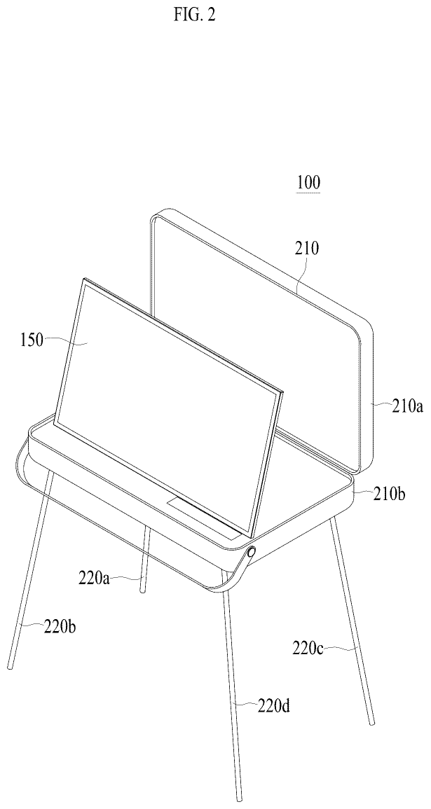

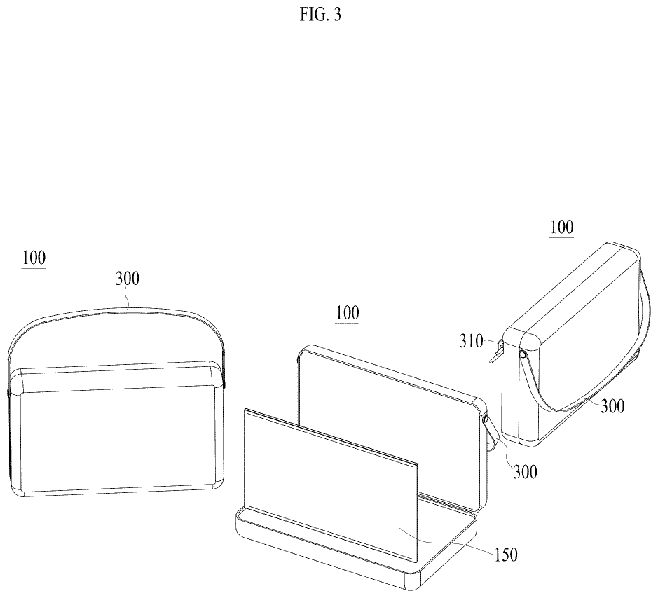

The voice (or audio) signal processed by the controller 180 may be audibly output to the audio output unit 160. In addition, the voice signal processed by the controller 180 may be input to the external output device through the external device interface unit 171. Although not shown in FIG. 2, the controller 180 may include a demultiplexer, an image processor, and the like, and a detailed description thereof will hereinafter be described with reference to FIG. 3.

In addition, the controller 180 may control the overall operation of the TV 100. For example, the controller 180 may control the tuner unit 111 to select a broadcast program corresponding to either a user-selected channel or a prestored channel.

In addition, the controller 180 may control the TV 100 by a user command or an internal program received through the user input interface unit 173. The controller 180 may control the display 150 to display an image. In this case, the image displayed on the display 150 may be a still image or a moving image, and may be a 2D image or a 3D image.

On the other hand, the controller 180 may display a predetermined 2D object in the image displayed on the display 150. For example, the object may be at least one of a connected web screen (newspaper, magazine, etc.), electronic program guide (EPG), various menus, widgets, icons, still images, moving images, and text.

Meanwhile, the controller 180 may modulate and/or demodulate the signal using an amplitude shift keying (ASK) scheme. Here, the ASK scheme may refer to a method for modulating a signal by differentiating the amplitude of a carrier wave according to data values or for restoring an analog signal to a digital data value according to the amplitude of the carrier wave.

For example, the controller 180 may modulate an image signal using the ASK scheme, and may transmit the modulated signal through a wireless communication module.

For example, the controller 180 may demodulate and process the image signal received through the wireless communication module using the ASK scheme.

Accordingly, the TV 100 may simply transmit and receive signals to and from other image display devices arranged adjacent to each other without using either a unique identifier such as a Media Access Control (MAC) address or a complex communication protocol such as TCP/IP.

On the other hand, the TV 100 may further include a photographing unit (not shown). The photographing unit may photograph a user. The photographing unit may be implemented as one camera, but is not limited thereto, and may be implemented by a plurality of cameras. On the other hand, the photographing unit may be embedded in the TV 100 or may be separately arranged on the display 150. The image information photographed by the photographing unit may be input to the controller 180.

The controller 180 may recognize the position of the user based on the image photographed by the photographing unit. For example, the controller 180 may recognize a distance (z-axis coordinates) between the user and the TV 100. In addition, the controller 180 may recognize the X-axis coordinate and the Y-axis coordinate within the display 150 corresponding to the user position.

The controller 180 may sense a user gesture based on an image photographed by the photographing unit, each of signals detected by the sensor unit, or a combination thereof.

The power-supply unit 190 may supply corresponding power to the TV 100. In particular, the controller 180 may be implemented as a System on Chip (SoC), a display 150 for displaying an image, and an audio output unit 160 for audio output.

Specifically, the power-supply unit 190 may include a converter (not shown) for converting AC power into DC power, and a DC/DC converter (not shown) for converting the level of DC power.

On the other hand, the power-supply unit 190 may receive power from the external power source, and may distribute the received power to the respective components. The power-supply unit 190 may be directly connected to the external power source to supply AC power, and may include a battery capable of being charged with electricity.

In the former case, the power-supply unit 190 may be used by connecting to a wired cable, and it is difficult for the power-supply unit 190 to move from one place to another place, and the movement range of the power-supply unit 190 is limited. In the latter case, the power-supply unit 190 can move from one place to another place, but the weight and volume of the power-supply unit 190 may increase as much as the weight and volume of the battery. In addition, for charging, the power-supply unit 190 should be directly connected to a power cable for a predetermined period of time or should be coupled to a charging cradle (not shown) for power supply.

The charging cradle may be connected to the display device through a terminal exposed to the outside. Alternatively, if the power-supply unit 190 approaches the charging cradle using a wireless interface, a built-in battery of the power-supply unit 190 may also be charged with electricity.

The remote controller 200 may transmit a user input to the user input interface unit 173. To this end, the remote controller 200 may use Bluetooth, Radio Frequency (RF) communication, infrared (IR) communication, Ultra-Wideband (UWB), ZigBee, or the like. In addition, the remote controller 200 may receive the image, voice, or data signal output from the user input interface unit 173, and may display or audibly output the received image, voice, or data signal.

On the other hand, the above-described TV 100 may be a fixed or mobile digital broadcast receiver capable of receiving digital broadcast signals.

Meanwhile, the block diagram of the TV 100 shown in FIG. 1 is disclosed for only for illustrative purposes for one embodiment of the present disclosure, and the respective components of the TV 100 shown in FIG. 1 can be integrated, added or omitted according to the specifications of the digital device 100 which is actually implemented.

That is, if necessary, two or more components may be combined into one component, or one component may be subdivided into two or more components. In addition, the functions performed in each block are intended to explain the embodiment of the present disclosure, and the specific operation or device does not limit the scope of the present disclosure.

FIG. 2 is a diagram showing the TV according to an embodiment of the present disclosure. Hereinafter, redundant descriptions will be omitted.

Referring to FIG. 2, the TV 100 is in a form in which the display module 150 is housed inside a housing 210. Here, the housing 210 includes an upper case 210a and a lower case 210b, and the upper case 210a and the lower case 210b may be structured so as to open and close.

In an embodiment, the audio output unit 160 may be included in the upper case 210a of the TV 100, and the controller 180, such as a main board, a power board, a power-supply unit 190, a battery, the interface unit 170, the sensing unit 120, and the input unit 130 (including a local key) may be accommodated in the lower case 210b. Here, the interface unit 170 may include a Wi-Fi module, a Bluetooth module, and an NFC module for communication with external devices, and the sensing unit 120 may include an illuminance sensor and an IR sensor.

In an embodiment, the display module 150 may include a DC-DC board, a sensor, and a low voltage differential signaling (LVDS) conversion board.

Additionally, in an embodiment, the TV 100 may further include four detachable legs 220a, 220b, 220c, and 220d. Here, the four legs 220a, 220b, 220c, and 220d may be attached to the lower case 210b to allow the TV 100 to be separated from the floor.

FIG. 3 is a diagram showing an example of using the TV according to an embodiment of the present disclosure. Hereinafter, redundant descriptions will be omitted.

FIG. 3 shows an example of using the TV 100 that does not include legs. Referring to FIG. 3, the TV 100 has a structure in which the display module is mounted in the upper case and the lower case as described above, and when the upper case and the lower case are closed, the TV can be changed into a structure that can be carried like a bag.

In an embodiment, the TV 100 may include a handle 300 on the upper case or the lower case. Here, the handle 300 may be a structure attached to the left and right sides of the upper case or the lower case such that the user can carry the housing with the upper case and the lower case closed. Here, the handle 300 may be made of a material that is easy for the user to hold, such as leather or plastic.

That is, the TV 100 includes the handle 300 when the upper case or the lower case is closed, and thus the user can easily carry and move the TV.

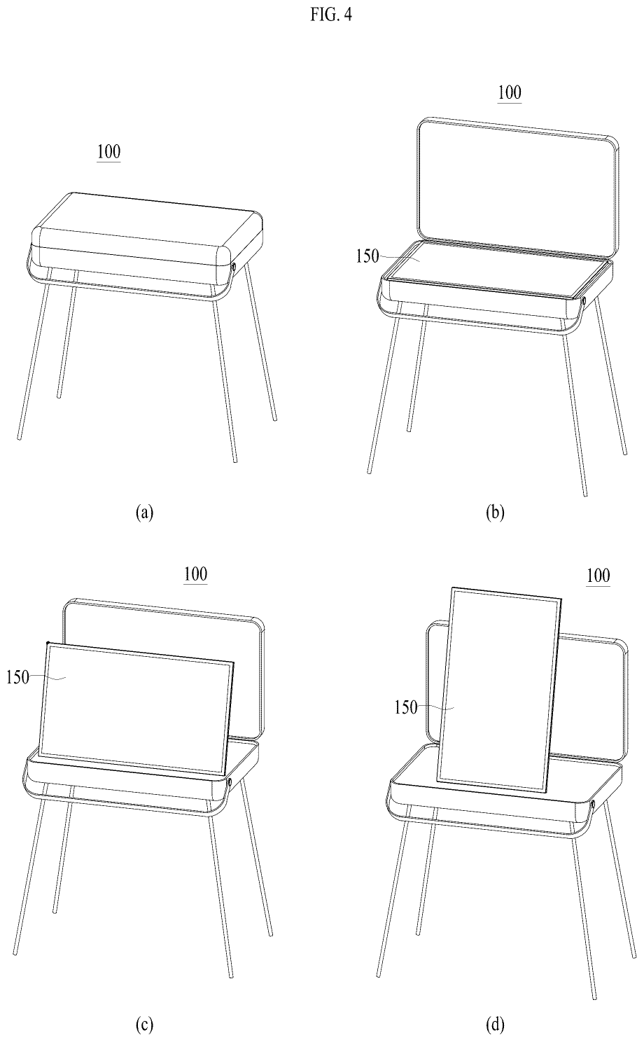

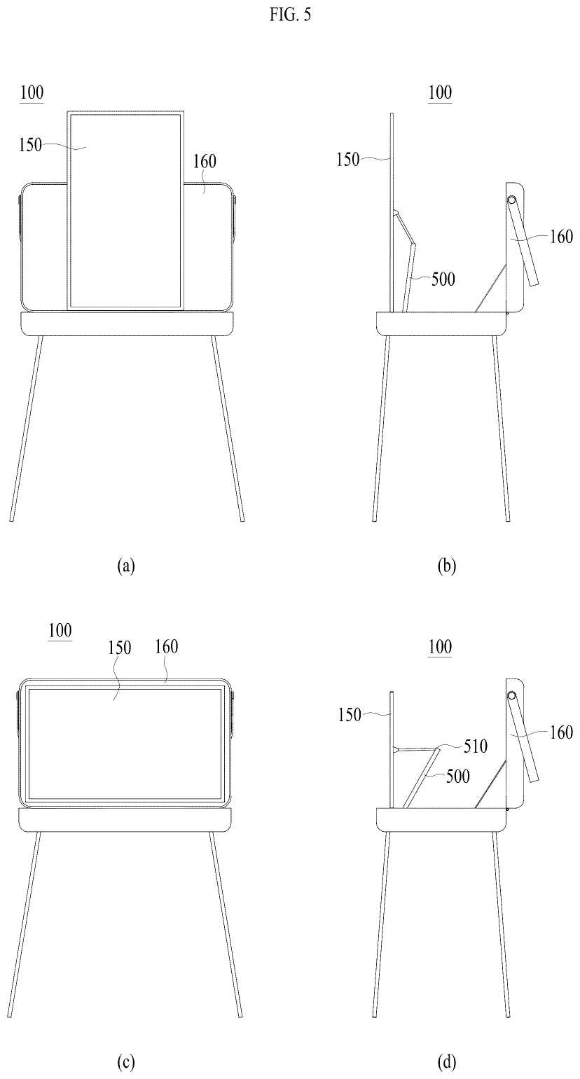

In addition, if necessary, the user can place the lower case on the floor and open the upper case to use the mounted display module 150. This will be described in detail with reference to FIG. 4 and FIG. 5.

In addition, in an embodiment, the TV 100 may further include a storage space 310 on the side of the lower case. Here, various modules described above in FIG. 2 may be stored in the storage space 310. In addition, the storage space 310 may include a space for storing a stylus or wireless earphones.

FIG. 4 is another diagram showing an example of using the TV according to an embodiment of the present disclosure. Hereinafter, redundant descriptions will be omitted.

In an embodiment of the present disclosure, the TV 100 may include four legs. Here, the four legs may be attached to the lower case to separate the TV 100 from the floor.

Accordingly, the user may use the TV 100 while moving the same and use the TV 100 in a fixed position separated from the floor.

(a) to (d) of FIG. 4 show an example of using the TV 100 in a fixed position by attaching the legs. Here, (a) of FIG. 4 shows a state in which the upper case of the TV 100 is closed, and (b) to (d) of FIG. 4 show a state in which the upper case is opened.

Specifically, (b) of FIG. 4 shows a state in which the display module 150 is housed in the lower case while the upper case is open. In other words, (b) of FIG. 4 shows a state in which the display module 150 is lying inside the lower case while the upper case is open. Even when the display module 150 is housed in the lower case, the display module 150 can be activated.

In an embodiment, the TV 100 may provide an editing mode while the display module 150 is stored in the lower case. Here, the editing mode may include a function of adding at least one of a memo function, a drawing function, or a voice recording function to the content.

That is, when the display module 150 is placed in the lower case, the TV 100 may determine that the user intends to view/appreciate content through the display module 150.

On the other hand, if the display module 150 is housed in the lower case, the TV 100 may determine that the user intends to edit the content output to the display module 150. Accordingly, the TV 100 may provide a function of editing content when the display module 150 is housed in the lower case.

(c) of FIG. 4 shows a state in which the display module 150 is placed horizontally in the lower case with the upper case open, and (d) of FIG. 4 shows a state in which the display module 150 is placed vertically in the lower case with the upper case open. Here, (c) and (d) of FIG. 4 show a state in which the display module 150 is erected using the lower case as a foothold.

In addition, in an embodiment, the TV 100 may automatically house or place the display module 150 in the lower case using a motor (not shown).

More specifically, when the upper case is opened, the TV 100 may automatically place the display module 150 horizontally or vertically on the lower case.

In addition, in another embodiment, when the upper case is opened, the TV 100 may primarily house the display module 150 in the lower case. Thereafter, the TV 100 may place the display module 150 on the lower case on the basis of a signal of touching the display module 150 or a signal input from the sensing unit or the input unit. For example, the user may place the display module 150 on the lower case by pressing down on the display module 150 housed inside the lower case. This will be described in detail with reference to FIG. 5.

FIG. 5 is a diagram showing the front and side of the TV according to an embodiment of the present disclosure. Hereinafter, redundant descriptions will be omitted.

(a) of FIG. 5 and (b) of FIG. 5 show a state in which the display module 150 is placed vertically, and (c) of FIG. 5 and (d) of FIG. 5 show a state in which the display module 150 is placed horizontally.

(a) and (c) of FIG. 5 are front views of the Tv 100, and (b) and (d) of FIG. 5 are side views of the TV 100.

In an embodiment, since the upper case may include the audio output unit 160, (a) of FIG. 5 shows the upper case in which the display module 150 is vertically placed and the audio output unit 160 is disposed at the rear end.

Referring to (b) of FIG. 5, the TV 100 may further include a support member 500 to vertically place the display module 150 in the lower case. That is, when the TV 100 is viewed from the side as in (b) of FIG. 5, the support member 500 may be included in the lower case and designed to have a foldable structure to vertically place the display module 150. Here, the support member 500 may be controlled by the motor of the TV 100 and may be manually operated by the user's hand.

Referring to (c) of FIG. 5, the TV 100 may have the display module 150 placed horizontally and include the audio output unit 160 at the rear end.

Referring to (d) of FIG. 5, the TV 100 may include the support member 500 to horizontally place the display module 150 on the lower case. Here, the support member 500 may be the same as the support member 500 in (b) of FIG. 5, but a hinge 510 included in the support member 500 may be folded further to horizontally place the display module 150.

In addition, in an embodiment, the display module 150 may be manually placed horizontally or vertically by the user's hand. In another embodiment, the display module 150 may be horizontally or vertically placed on the lower case under the control of the TV 100. Here, the TV 100 may horizontally or vertically place the display module 150 on the basis of a control signal of the user (detection through the sensing unit or the input unit).

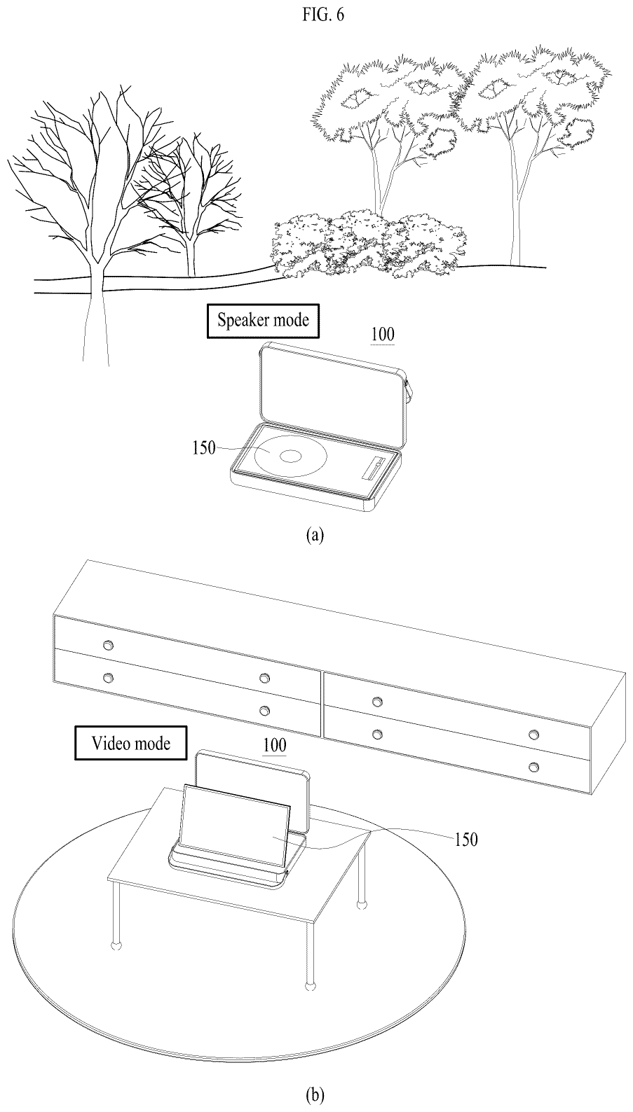

FIG. 6 is a diagram illustrating modes of the TV according to an embodiment of the present disclosure. Hereinafter, redundant descriptions will be omitted.

In an embodiment of the present disclosure, the TV 100 may detect opening of the lower case of the housing. That is, the user may open the upper case of the TV 100 and switch to the state of (a) of FIG. 6 or (b) of FIG. 6.

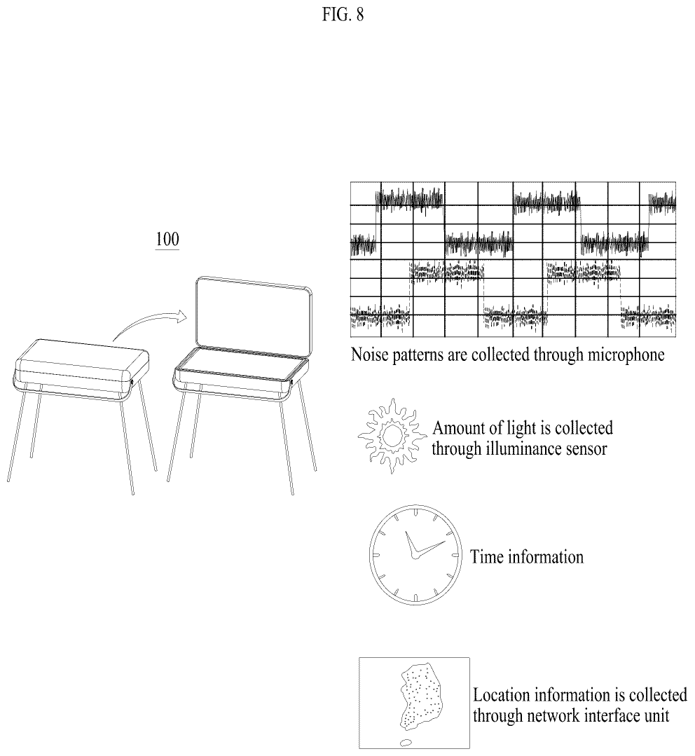

Accordingly, the TV 100 may determine the current location of the TV. At this time, the TV 100 may use various sensors to determine the current location of the TV 100. This will be described in detail with reference to FIG. 8.

The TV 100 may determine whether the current location is the same as the location immediately before shutdown.

In an embodiment, the TV 100 may operate in the mode immediately before shutdown if the current location is the same as the location immediately before shutdown. At this time, modes may include a first mode, a second mode, and a third mode.

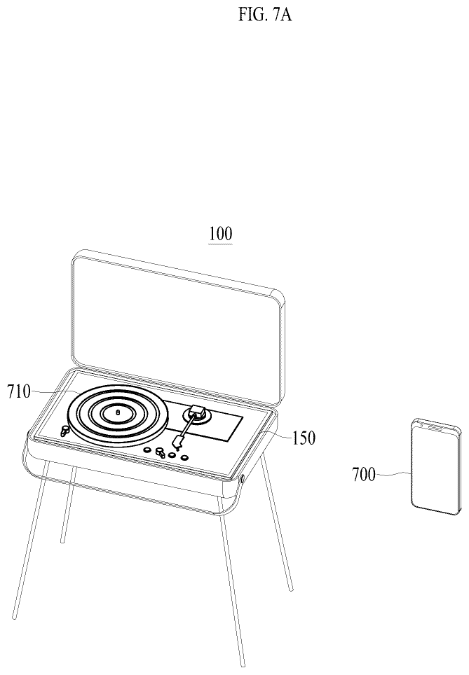

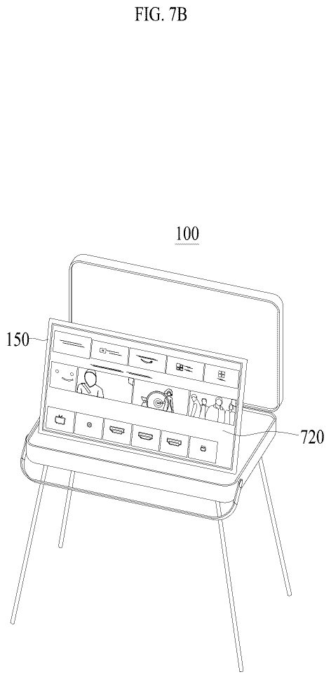

(a) of FIG. 6 illustrates the first mode and the third mode, and (b) of FIG. 6 illustrates the second mode. Here, the first mode and the third mode may be referred to as a speaker mode, and the second mode may be referred to as a video mode. This will be described again with reference to FIG. 7a and FIG. 7b.

More specifically, the first mode and the third mode are modes in which the display module 150 is maintained in a state of being coupled to the housing, and the second mode is a mode in which the display module 150 is in a standing state in the housing.

Here, the first mode and the third mode are different in that the current location and time of the TV 100 differ by a certain amount of time compared to the previous use. That is, the TV 100 may operate in the third mode, not the first mode. At this time, the third mode corresponds to a mode for connecting a connectable external device based on user selection.

More specifically, the TV 100 may operate in the third mode when there is a difference of a certain position or time or more between at least one of the location or time immediately before shutdown and at least one of the current location or current time.

At this time, the TV 100 may switch to an external device connection standby mode without connecting to an external device (which will be described later in FIG. 7a) that has a previous connection history. Accordingly, the TV 100 may wait for a control signal of the user in the third mode without being connected to an external device. Later, when the user connects an external device to the TV 100, the TV 100 may perform the subsequent operation.

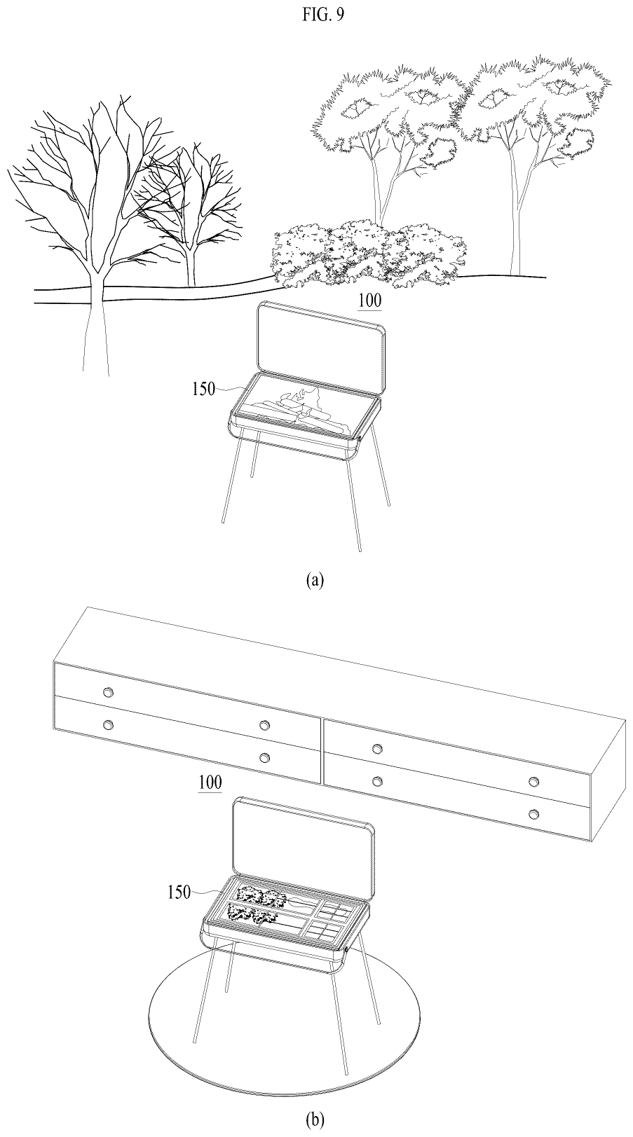

In addition, in an embodiment, the TV 100 may output content on the basis of the current location and current time in the third mode. This will be described in detail with reference to FIG. 9.

That is, the TV 100 may house or place the display module 150 in the housing of the TV 100 in various ways as described above in FIG. 4 and FIG. 5. The present disclosure proposes a method of determining which mode the TV 100 will be used in and which content will be output on the display module 150 by considering various types of environmental information such as the current location and current time of the TV 100 when the top of the housing is opened.

FIG. 7a and FIG. 7b are diagrams illustrating an example of connecting a device based on a mode of the TV according to an embodiment of the present disclosure. Hereinafter, redundant descriptions will be omitted.

In an embodiment of the present disclosure, FIG. 7a is a diagram illustrating the first mode, and FIG. 7b is a diagram illustrating the second mode. As described above, the first mode illustrated in FIG. 7a may represent a speaker mode, and the second mode illustrated in FIG. 7b may represent a video mode.

Referring to FIG. 7a, when the TV 100 executes a mode immediately before shutdown, the TV 100 may automatically connect an external device 700 that was last connected to the TV 100. Here, the external device 700 may include a smartphone, a tablet computer, a laptop, or the like.

More specifically, when the upper case of the housing of the TV 100 is open, and the current location of the TV 100 is the same as the location immediately before shutdown, the TV 100 may execute the first mode. Here, the first mode is the speaker mode, and the TV 100 may be controlled to maintain the display module 150 in a state of being coupled with the housing.

In an embodiment, the TV 100 may directly connect to the external device 700 that was connected during previous use through a Bluetooth connection or the like. At this time, the TV 100 may use the communication module that was connected with the external device 700 during previous use.

In an embodiment, when the TV 100 operates in the first mode, the TV 100 may output an audio signal of the external device 700 through the audio output unit attached to the upper case of the housing. At this time, the TV 100 may output an audio-specific theme screen 710 such as a turntable on the display module 150 while simultaneously outputting the audio signal received from the external device 700.

On the other hand, FIG. 7b shows an example in which the TV 100 operates in the second mode, which is the video mode. That is, referring to FIG. 7b, the user may open the upper case of the TV 100 and maintain the display module 150 in a standing state in the lower case of the housing.

In addition, an embodiment associated with FIG. 7a is available. More specifically, the user may use the TV 100 in the first mode by attaching the display module 150 to the lower case of the housing, and then change the display module 150 to the standing state by detaching the same from the lower case. Accordingly, the TV 100 may operate in the second mode. That is, the user's action of detaching the display module 150 from the lower case may be a trigger for the second mode.

In an embodiment, when the TV 100 operates in the second mode, a content selection screen 720 may be output on the display module 150.

More specifically, the TV 100 may terminate output of an audio signal being output (or played) when operating in the first mode. Thereafter, the TV 100 may output the content selection screen 720 for video viewing through the display module 150. Here, the content selection screen 720 may correspond to an initial screen of a general TV 100.

That is, even if an embodiment of the present disclosure is a portable TV 100, the portable TV 100 can operate like a general TV 100 when used in the video mode, other than an embodiment in which it is used in the speaker mode. To this end, the TV 100 may output the content selection screen 720 on the display module 150 when operating in the second mode and receive a control signal from the user.

Thereafter, the TV 100 may output various types of content received from a broadcast receiver on the basis of a control signal of a remote control device (not shown).

FIG. 8 is a diagram illustrating an example of detecting movement of the location of the TV according to an embodiment of the disclosure. Hereinafter, redundant descriptions will be omitted.

In an embodiment, the TV 100 may determine the current location and current time of the TV 100 through various means.

More specifically, referring to FIG. 8, the TV 100 may determine at least one of the current location or the current time as the upper case of the housing is opened.

To this end, in an embodiment, the TV 100 may further include a microphone. The TV 100 may determine the current location of the TV 100 on the basis of noise information received through the microphone. Here, the information may include a noise pattern.

In an embodiment, the TV 100 may collect first noise information received through the microphone when the upper case of the housing is opened. The TV 100 may determine the current location of the TV 100 by comparing a noise pattern included in the first noise information with the existing noise pattern.

For example, if the TV 100 is used indoors, a noise pattern may be constant. On the other hand, if the TV 100 is located outdoors on a certain day, noise information received through the microphone when the upper case of the TV 100 is opened may be different from the noise pattern indoors. Accordingly, the TV 100 may determine whether the current location is indoors or outdoors.

In another embodiment, the TV 100 may further include an illuminance sensor. The TV 100 may determine the current location of the TV 100 on the basis of the amount of light detected through the illuminance sensor. That is, the amount of light collected through the illuminance sensor may be different indoors and outdoors. Accordingly, the TV 100 may determine whether the current location of the TV 100 is indoors or outdoors through the illuminance sensor.

In addition, in another embodiment, the TV 100 may receive location information of the TV 100 through the network interface unit described above in FIG. 1. Accordingly, the TV 100 may determine the current location on the basis of the received location information.

In addition, the TV 100 may more precisely determine location information of the TV 100 by synthesizing the method described in FIG. 8. For example, the TV 100 is able to recognize that the current location is Hangang Park on the basis of information received through the network interface unit or the like upon determining that the current location is outdoors. Accordingly, the TV 100 can compare the determined current location with the previous location and select and execute the first mode or the third mode.

FIG. 9 is a diagram illustrating an example of outputting an image on the basis of situation information of the TV according to an embodiment of the present disclosure. Hereinafter, redundant descriptions will be omitted.

FIG. 9 illustrates an example available when the display module 150 is attached to the lower case of the housing, as in the above-described first mode and third mode.

That is, in both a case where the location immediately before shutdown is the same as the current location position as in the first mode and a case where the location immediately before shutdown is different from the current location as in the third mode, the TV 100 may output content that matches a theme through the display module 150.

In an embodiment, the network interface unit of the TV 100 is connected to a server, and the TV 100 may receive image information regarding the current location of the TV 100 from the server. The TV 100 may output the image information through the display module 150. At this time, the TV 100 may receive the image information based on the current time.

More specifically, referring to (a) of FIG. 9, upon determining that the current location is outdoors and the current time is night, the TV 100 may output a bonfire theme through the display module 150. In an embodiment, the TV 100 may transmit information representing that the current location is outdoors and the current time is night to the server and receive image information corresponding to the bonfire theme based on the information representing that the current location is outdoors and the current time is night from the server. At this time, the server may search for an image theme based on the current location and the current time and transmit the same to the TV 100.

In addition, referring to (b) of FIG. 9, upon determining that the current location is indoors and the current time is daytime, the TV 100 may output a window theme with sunshine through the display module 150. The TV 100 may transmit information representing that the current location is indoors and the current time is daytime to the server and receive image information corresponding to a window theme with sunshine based on the information representing that the current location is indoors and the current time is daytime from the server.

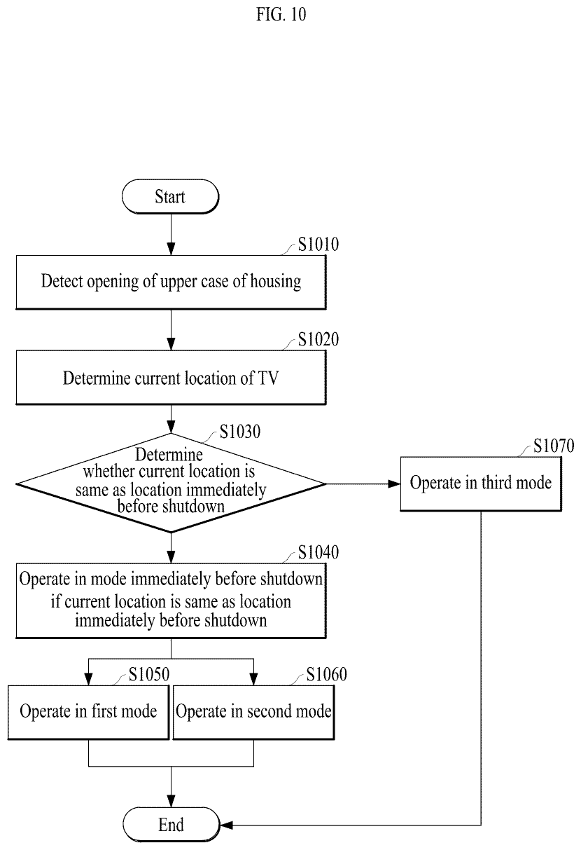

FIG. 10 is a flowchart illustrating a method of controlling a TV according to an embodiment of the present disclosure. Hereinafter, redundant descriptions will be omitted.

Referring to FIG. 10, in step S1010, the TV may detect that the upper case of the housing is opened.

In step S1020, the TV may determine the current location of the TV.

In step S1030, the TV may determine whether the current location is the same as the location immediately before shutdown. In an embodiment, the TV may determine the current location of the TV on the basis of noise information received through a microphone. Here, the noise information may include a noise pattern. More specifically, the TV may collect noise information received through the microphone when the upper case of the housing is opened, and determine the current location of the TV by comparing the noise pattern included in the collected noise information with existing noise patterns. To this end, the TV may store the existing noise patterns in a memory.

In an embodiment, the TV may determine the current location of the TV on the basis of the amount of light detected by the illuminance sensor. In another embodiment, the TV may receive the current location information of the TV through the network interface unit and determine the current location of the TV on the basis of the received location information.

In step S1040, if the current location is the same as the location immediately before shutdown, the TV may operate in the mode immediately before shutdown. Here, the mode immediately before shutdown may include the first mode and the second mode. In an embodiment, when the TV executes the mode immediately before shutdown, the TV may automatically connect to an external device that was last connected to the TV.

In step S1050, the TV may operate in the first mode. Here, the first mode represents a mode in which the display module of the TV maintains a state of being coupled with the housing. In an embodiment, if the TV operates in the first mode, the TV may output an audio signal of the external device through the audio output unit attached to the upper case of the housing.

In step S1060, the TV may operate in the second mode. Here, the second mode represents a mode in which the display module of the TV is in a standing state in the housing. In an embodiment, the TV may output a content screen on the display module when operating in the second mode.

In step S1070, if the current location is not the same as the location immediately before shutdown, the TV may operate in the third mode. Here, the third mode represents a mode for connecting another connectable external device on the basis of user selection. In an embodiment, the TV may determine the time immediately before shutdown of the TV, and if the current time in step S1010 is different from the time immediately before shutdown, the TV may operate in the third mode. That is, the TV may operate in the third mode if at least one of the current location or the current time is different from at least one of the location or time immediately before shutdown.

In addition, the embodiments described in FIG. 6 to FIG. 9 may be performed in the same manner as in FIG. 10.

The above detailed description should not be construed as restrictive in all respects and should be considered exemplary. The scope of the present disclosure should be determined by a reasonable interpretation of the appended claims, and all changes within the equivalent scope of the present disclosure are included in the scope of the present disclosure.

### INDUSTRIAL APPLICABILITY

The present disclosure has industrial applicability because it can be repeatedly implemented in a portable TV.

What is claimed is:

1. A portable TV comprising:
a display module for outputting content;
a housing accommodating the display module;
four legs attachable/detachable to/from a lower case of the housing; and
a controller,
wherein the controller is configured to:
detect opening of an upper case of the housing;
determine a current location of the TV;
determine whether the current location is the same as a location immediately before shutdown; and
operate in a mode immediately before shutdown if the current location is the same as the location immediately before shutdown,
wherein the mode includes a first mode and a second mode,
wherein the first mode is a mode in which the display module maintains a state of being coupled with the housing, and the second mode is a mode in which the display module is in a standing state in the housing.

2. The portable TV of claim 1, wherein the controller automatically connects a first external device last connected to the TV when operating in the mode immediately before shutdown.

3. The portable TV of claim 2, wherein the controller outputs an audio signal of the first external device through an audio output unit attached to the upper case of the housing when the TV operates in the first mode.

4. The portable TV of claim 1, wherein the controller outputs a content selection screen on the display module when the TV operates in the second mode.

5. The portable TV of claim 1, wherein, when the current location is different from the location immediately before shutdown, the TV operates in a third mode, and the controller connects a second external device connectable on the basis of user selection.

6. The portable TV of claim 5, wherein the controller determines a time immediately before shutdown of the TV, and when a current time is different from the time immediately before shutdown, the TV operates in the third mode.

7. The portable TV of claim 1, further comprising a microphone,
wherein the controller determines the current location of the TV on the basis of first noise information received through the microphone,
wherein the noise information includes a noise pattern.

8. The portable TV of claim 7, wherein the controller collects second noise information received through the microphone when the upper case of the housing is opened, and compares a noise pattern included in the second noise information with existing noise patterns.

9. The portable TV of claim 1, further comprising an illuminance sensor,
wherein the controller determines the current location of the TV on the basis of an amount of light detected through the illuminance sensor.

10. The portable TV of claim 1, further comprising a network interface unit,
wherein the controller receives location information of the TV through the network interface unit, and determines the current location of the TV on the basis of the location information.

11. The portable TV of claim 10, wherein the network interface unit is connected to a server,
wherein the controller receives image information regarding the current location of the TV from the server, and outputs the image information through the display module.

12. The portable TV of claim 11, wherein the controller receives the image information on the basis of the current time.

13. A method of controlling a portable TV,
wherein the TV comprises a display module for outputting content, a housing accommodating the display module, and four legs attachable/detachable to/from a lower case of the housing, the method comprising:
detecting opening of an upper case of the housing;
determining a current location of the TV;
determining whether the current location is the same as a location immediately before shutdown; and
operating in a mode immediately before shutdown if the current location is the same as the location immediately before shutdown,
wherein the mode includes a first mode and a second mode,
wherein the first mode is a mode in which the display module maintains a state of being coupled with the housing, and the second mode is a mode in which the display module is in a standing state in the housing.

14. The method of claim 13, further comprising automatically connecting a first external device last connected to the TV when the mode immediately before shutdown is executed.

15. The method of claim 13, further comprising outputting a content selection screen on the display module when the TV operates in the second mode.

16. The method of claim 13, further comprising operating the TV in a third mode when the current location is different from the location immediately before shutdown,
wherein the third mode is a mode for connecting a second external device connectable on the basis of user selection.
